(19) United States
(12) Patent Application Publication
(10) Pub. No.: US 2020/0410551 A1
(43) Pub. Date: Dec. 31, 2020

(54) MACHINE-LEARNING TECHNIQUES TO SUGGEST TARGETING CRITERIA FOR CONTENT DELIVERY CAMPAIGNS

(71) Applicant: Microsoft Technology Licensing, LLC, Redmond, WA (US)

(72) Inventors: Runfang Zhou, Redmond, WA (US); Qi Guo, Redmond, WA (US); Jae Oh, San Mateo, CA (US); Darren Chan, Redmond, WA (US); Wenxiang Chen, Redmond, WA (US); Chien-Chun Hung, Redmond, WA (US); Revant Kumar, Sunnyvale, CA (US); Rohan Ramanath, Saratoga, CA (US); Sara Smoot Gerrard, Redmond, WA (US); Tanvi Motwani, Redmond, WA (US); Alexandre Patry, Redmond, WA (US); William Tang, Redmond, WA (US); Liu Yang, Sunnyvale, CA (US)

(21) Appl. No.: 16/457,454

(22) Filed: Jun. 28, 2019

(51) Int. Cl. G06Q 30/02; G06N 20/00

(52) U.S. Cl. CPC G06Q 30/0276; G06Q 30/0201; G06Q 30/0205; G06N 20/00

(57) ABSTRACT

Techniques for suggesting targeting criteria for a content delivery campaign are provided. An affinity score representing an affinity between the attribute values of each pair of multiple pairs of attribute values is computed. First input indicating a particular attribute value for a particular attribute type is received through a user interface for creating a content delivery campaign. The user interface includes fields for inputting attribute values for multiple attribute types that includes the particular attribute type. In response to the first input and based on affinity scores associated with the particular attribute value, a set of suggested attribute values is identified. The user interface is updated to include the set of suggested attribute values. Second input indicating a selection of a particular suggested attribute value is received. The particular suggested attribute value is added to the content delivery campaign.

### TECHNICAL FIELD

The present disclosure relates to content item delivery across one or more computer networks and, more particularly, to generating a target audience for a content delivery campaign.

### BACKGROUND

A content delivery system publishes electronic content from one or more content providers to users of the content delivery system. Some content providers desire to target users who will view their content for more effective content delivery. To do so, content providers rely on the content delivery system that delivers the electronic content to computing devices of the users.

Targeting the users for a particular content delivery campaign is often carried out by manually specifying search constraints for the target users or manually setting up the targeting criteria. Existing approaches may take a considerable amount of time for the content provider to research the roles of the candidate users and related industries for which the content providers are sourcing. Accordingly, a more efficient, smarter and more automated tool that can help the content provider to build a highly relevant target audience for a content delivery campaign may be desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2A-2C are example user interfaces for suggesting targeting criteria for content delivery campaigns, in an embodiment;

FIG. 3 is a flow diagram that depicts a process for suggesting targeting criteria for content delivery campaigns, in an embodiment; and

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques for suggesting one or more targeting criteria for a content delivery campaign are provided. In one technique, a content provider inputs one targeting criterion in a campaign creation interface. The targeting criterion is transmitted over a computer network to an online service that identifies one or more additional targeting criteria based on the targeting criterion. The one or more additional targeting criteria may include targeting criteria of the same type and/or different type than the original targeting criterion. The campaign creation interface is updated to include the one or more additional targeting criteria and an option to select the one or more additional targeting criteria, either individually or collectively or both. In a related technique, the one or more additional criteria are identified based on affinities of the one or more additional criteria with the original targeting criterion. The affinities may be based on a co-occurrence of each pair of attribute values in one or more data sets.

Embodiments described herein improve the utility of electronic content delivery methods by suggesting targeting criteria for content delivery campaigns. Embodiments improve user experience by providing a user interface that allows a content provider to view and select suggested attribute values for the targeting criteria of a content delivery campaign without requiring the content provider to manually specify each search constraint for the target audience. Embodiments improve user experience by pinpointing a highly relevant audience based on a rich set of data using, optionally, a machine-learned model.

### System Overview

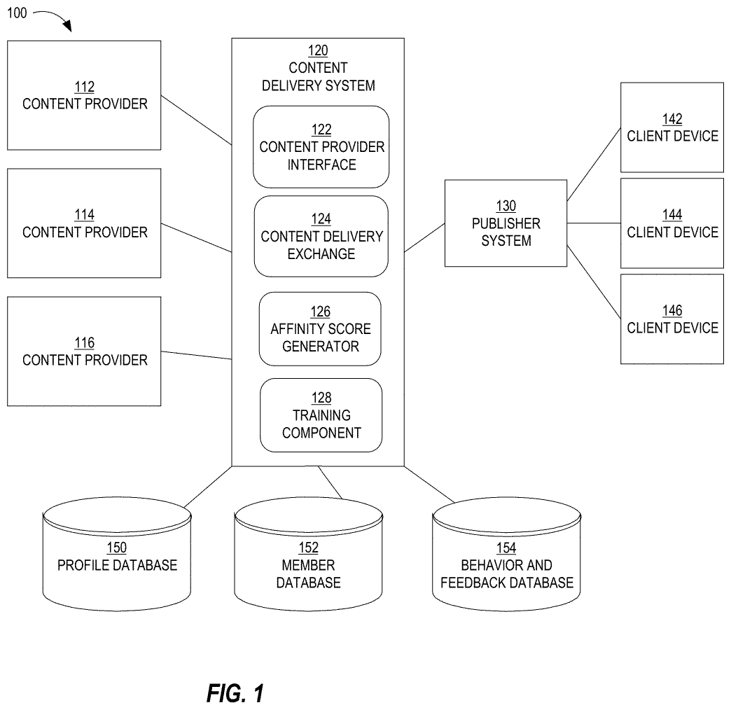

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120. A user may be a registered entity (e.g., member) of an online service, such as a social network service.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns, (2) a content delivery exchange 124 that conducts content item selection events in response to content requests from a third-party content delivery exchange and/or from publisher systems, such as publisher system 130, (3) an affinity score generator 126 that genets an affinity score between attributes of criteria for selecting target audience for one or more content delivery campaigns, and (4) a training component 128 that trains a machine-learned model to generate the affinity score and determine weights corresponding to features of the machine-learned model.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties. In some embodiments, the content delivery system and the publisher system are a social networking system such as LinkedIn™.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Content Delivery Campaigns

Each content provider establishes a content delivery campaign with content delivery system 120 through, for example, content provider interface 122. An example of content provider interface 122 is Campaign Manager™ or LinkedIn Audience Network™ provided by LinkedIn. Content provider interface 122 comprises a set of user interfaces that allows a representative of a content provider to create an account for the content provider, creates one or more content delivery campaigns within the account, establishes one or more attributes of each content delivery campaign, and selects a set of targeting audience for each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented with different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, install a particular application, or become aware of an enterprise or initiative, whether commercial, charitable, or political. When the users perform exemplary actions that meet the purposes of the campaigns, it is determined that a conversion event has occurred with respect to the campaign.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users on one or more publishers. In an embodiment, a content delivery campaign defines who receives a content item and where in the sense that a content item is prevented from being displayed through one publisher application but is allowed to be displayed through another publisher application. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc.

Examples of characteristics (e.g., attributes) of a user include demographic information, geographic information (e.g., of an employer), job title, employment status, academic degrees earned, academic institutions attended, former employers, current employer, number of connections in a social network, number and type of skills, number of endorsements, and stated interests. Some member characteristics may be generated using one or more machine learning techniques, in both features (e.g., “standardized” job titles) and in probabilistic (or confidence-based) member mapping from device ID (e.g., LiveRamp). Member characteristics and attributes are stored in member database 152. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

### Content Provider Interface

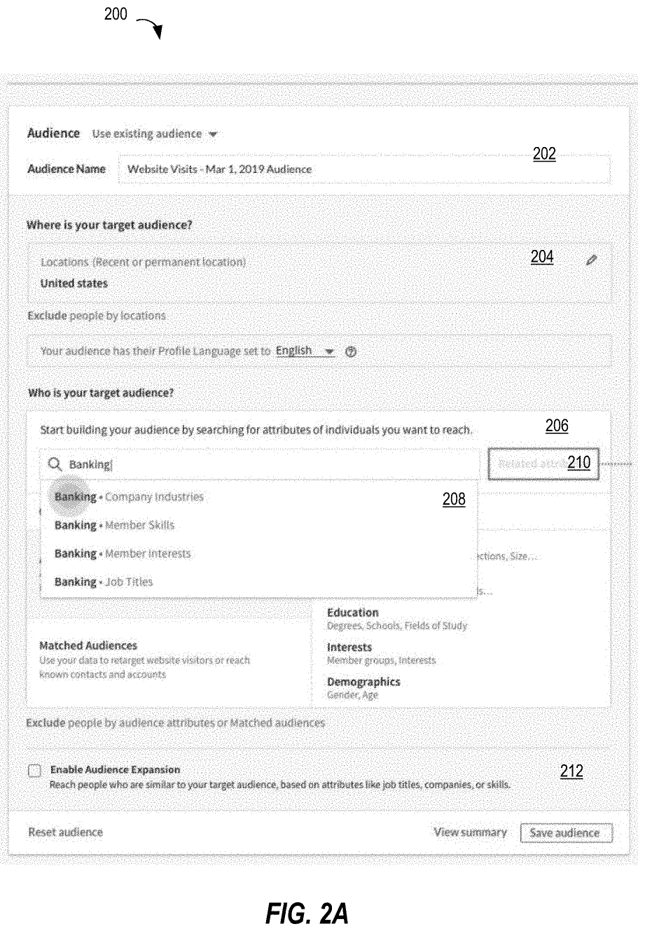

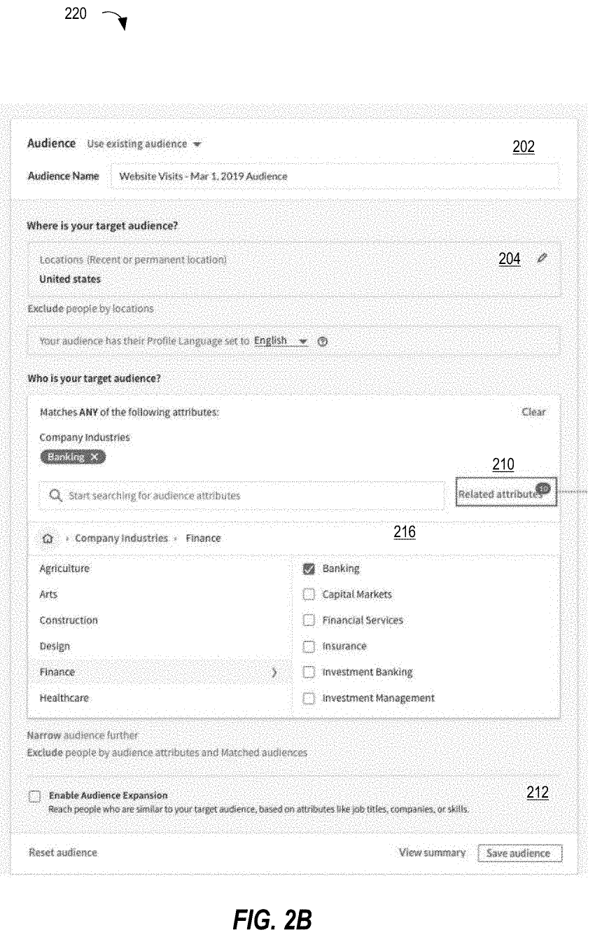

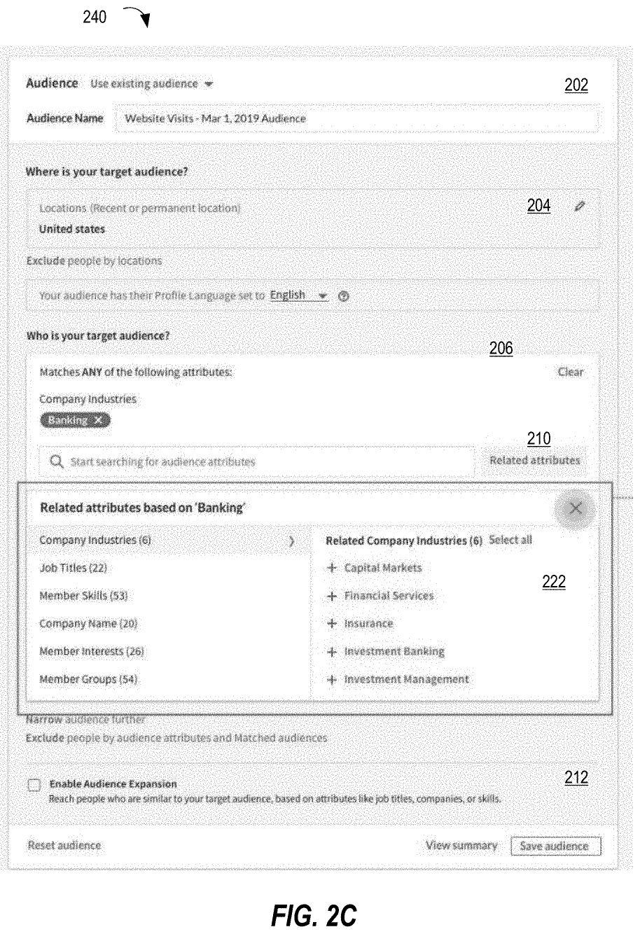

Content provider interface 122 comprises a set of user interfaces that allows a representative of a content provider to establish one or more attributes (e.g., facets) of each content delivery campaign and select a set of target audiences for each content delivery campaign as shown in FIG. 2A-2C. For example, if the content provider desires to deliver a particular campaign to a set of users who possesses (or do not possess) certain attributes, then the content provider can simply input a search query, and expand or refine the target audience by selecting the suggestions made by content delivery system 120 based on the search query through content provider interface 122.

When the content provider initiates specifying the targeting criteria through content provider interface 122, content delivery system 120 may suggest attribute values of users that content delivery system 120 determines to be relevant to already-selected targeting criteria. Alternatively, content delivery system 120 suggests attribute values that are likely to generate a higher click-through rate or a conversion event of a content delivery campaign. A suggestion of attributes made by content delivery system 120 allows the content provider to find a good audience that meets the targeting criteria of a campaign without manually specifying a search constraint which may require a considerable amount of time.

In some embodiments, the suggested attribute values are of the same type of attribute as the selected (or already-specified) attribute value. For example, if the content provider selects a “software engineer” (title facet) for a particular content delivery campaign, then content delivery system 120 can suggest a “computer engineer” job (title facet) as a relevant attribute if content delivery system 120 determines a close distance in the similarities between the titles and determines that the two titles are similar enough to meet a threshold for a suggestion.

In related embodiments, the suggested attribute values are of different types (e.g., cross-facet suggestion). For example, if the content provider selects a “software engineer” (title facet) for a particular content delivery campaign, then content delivery system 120 may suggest a “Mountain View” (location facet) as a relevant attribute if content delivery system 120 determines that the “Mountain View” location attribute is relevant to the “software engineer” job title attribute.

### Profile Database

Content delivery system 120 indexes the entity (user) profiles that are stored in profile database 150 and an index is queried using a (e.g., logistic) regression model. The logistical regression model is trained using profile tracking data. Features such as skills, titles, and/or locations are extracted from the set of entity profiles. Candidate entities are ranked using the regression model to get similar profiles. In some embodiments, cosine similarity metrics are used to measure the similarities between the features. A set of top similar profiles (e.g., 100) is identified for each member and stored in profile database 150. Thus, if there are 1 million active entity profiles stored in profile database 150, then a total of 100 million similar pairs (1 million*100) can be identified and stored in the profile database 150.

### Affinity Score Generator

For each similar profile pair of the set of top similar profiles, affinity score generator 126 counts the co-occurrence between two attribute values (same or different types of attributes). In other words, affinity score generator 126 counts how many times a certain attribute pair is identified in an entity profile and 100 similar profiles (e.g., how many times “San Francisco”-“Software Engineer” pair have been identified in a member A's profile and the 100 similar profiles for member A). An affinity score can be calculated according to:

G-Test value of (tᵢ,tₖ)=(N_{i,k})/(1/(S−1))(ΣᵢN_{i,j}−N_{i,k})

where tᵢ is a first attribute value (e.g., “Software Engineer”) and tₖ is a second attribute value (e.g., “Software developer”), N_{i,k} is the total number of attribute pairs (tᵢ,tₖ) from similar profile data, S is the total number of titles related to attribute tᵢ from similar profile data, N_{i,j} is the total number of attribute pairs (tᵢ,tⱼ) from similar profile data, and ΣⱼN_{i,j} means N_{i,1}+N_{i,2}+ . . . +N_{i,s}.

G-Test is a likelihood-ratio or maximum likelihood statistical significance test. In other words, the G-test value is a normalized co-occurrence count. After the G-Test score is generated, affinity score generator 126 normalizes the G-Test value to (0,1) using a SIGMOID logistic function

$$( e . g . , \frac{1}{1 + {e}^{- G - Test}} ) .$$

Generating the G-test value can be performed offline.

In some embodiments, affinity score generator 126 calculates a per market affinity score. A per market affinity score (e.g., local affinity score) is a market specific score that is customized based on a specific market (e.g., country). For example, “sk.au” represents a per market affinity score for skills in the Australia market. A per market affinity score is calculated because different naming conventions of attributes are used in different regions. For example, in one country, a title “software developer” may be more prominently used and in another country, a title “software engineer” may be more prominently used. In this case, the per market affinity score can be used to capture different naming conventions and generates a more accurate score that captures the different titles that are specific to the particular regions.

In some embodiments, content delivery system 120 uses an affinity score and per-market affinity score generated by affinity score generator 126 to determine a relevant attribute for suggestions. The affinity score and the per-market affinity score are stored in profile database 150.

### Training Component

Training component 128 uses one or more supervised machine learning techniques to train a machine-learned model (e.g., an entity ranking model) to score the candidate pairs. Coefficients/weights for each feature are learned using the profile tracking data stored in behavior and feedback database 154. The feedback data may be received from a content provider who provides input (by selecting a suggested attribute) through content provider interface 122. For each candidate pair, training component 128 computes a score using the below equation:

Weight₁*affinity score+Weight₂*per market affinity score+Weight₃*industry match+Weight₄*Location

Although four features are used in the above equation, any attribute values or score values can be used. In some embodiments, one or more machine learning techniques are used to determine which of the features are more important for calculating the accurate scores. Generally, more important features have higher weights than less important features. For example, an affinity score feature may be assigned a higher weight than a per market affinity score if it is determined that the affinity score feature is a more determinative factor than the per market affinity score feature when calculating the score. The machine learning techniques are used to determine a coefficient (weight) for each feature that is incorporated into the machine-learned model and changes the coefficient when the machine learned model is updated using another training data set.

One or more machine learning techniques are used to train a machine-learned model using a set of historical data. Non-limiting examples of machine learning techniques include Linear Regression, Support Vector Machines, Random Forest, Gradient Boosting Decision Trees, and Artificial Neural Networks.

In one embodiment, training data is used to strengthen or retrain the machine-learned model. Based on the behavior and feedback data, the machine-learned model can be improved. For example, if selections of the pairs are not made (negative feedback), then negative numerical values may be assigned to the unselected pairs which indicate that the unselected pairs are negatively responsible for computation of the output. On the other hand, if selections of the pairs are made (positive feedback), then positive numerical values may be assigned to the selected pairs. The machine-learned model may be trained using the samples of the pairs which can strengthen the machine-learned model.

### Example Graphical User Interface

FIGS. 2A-2C are example user interfaces for suggesting targeting criteria, in an embodiment.

FIG. 2A is a first example user interface 200, provided by content delivery system 120 that displays a set of content items that involves an article, image and/or text that originates from a content provider, in an embodiment. First example user interface 200 includes:
an audience name panel 202 that specifies a name of a target audience defined by targeting criteria;
an audience location panel 204 that specifies a location criterion;
a facet browser 206 for browsing attributes of entities;
an audience expansion option 212.

First example user interface 200 is an example of content provider interface 122. In some embodiments, first example user interface 200 is not available to users of client devices 142, 144, 146 because the users of client devices 142, 144, 146 do not have appropriate permission to make suggestions or edits to the content delivery campaigns. Users may view a set of content items associated with the content delivery campaigns. A user may be a registered entity (e.g., member) of an online service, such as a social network service.

Audience name panel 202 includes an input field in which a content provider can type a particular audience name. In one embodiment, the content provider may enter a specific audience name. In another embodiment, the content provider can simply click a pre-existing audience name that has been auto-populated.

Audience location panel 204 includes an input field in which a content provider can type a particular location criterion to the target audience for a particular content delivery campaign. In one embodiment, the content provider can simply click a desired location (e.g., the United States) from among multiple candidate locations that have been pre-populated. In a related embodiment, the content provider can exclude a set of users associated with certain locations if the set of users is not intended to be in a target audience.

Facet browser 206 enables the content provider to build and tailor the target audience by searching for attributes (and/or attribute values) of users the content provider wants to reach. Facet browser 206 includes an input field in which the content provider can input a specific attribute value (e.g., banking). In response to the input query, one or more attribute values corresponding to the input may be displayed as selectable options 208 for the content provider to choose from. Non-limiting examples of the attributes include company industry, entity skills, entity interests, job title, entity interest, job seniority, company, job experience, education, interest, job function, years of experience, field of study, or demographic information. A facet browser is referred to as an attribute browser that enables the content provider to select attributes of interests.

For example, as shown in first user interface 200, in response to the input query (e.g., banking), one or more different attributes, such as a company industry, an entity skill, an entity interest, and a job title, that are related to the input query are displayed. Each of the displayed attributes corresponds to the input query (banking). The content provider can simply click the attribute of interest and a target audience can be filtered based on the selection.

Facet browser 206 may include a related attribute button 210 that is responsive to input via a pointing device such as a mouse, trackball or keyboard. In an embodiment, input selecting related attribute button 210 causes opening of a related attribute window 222 (shown in FIG. 2C). Related attribute button 210 may be implemented as a toggle such that repeated selection causes removal of related attribute window 222. Related attribute button 210 is disabled by default or when there is no selection of an attribute in facet browser 206.

Audience expansion option 212 includes a checkbox that enables the content provider to expand the target audience to reach the maximum number of entities. Audience expansion can be based on the similarities of selected attribute values. By clicking the checkbox, the audience expansion function is enabled.

FIG. 2B is a second example user interface 220 after an attribute value selection is made by the content provider. A selection of the attribute value causes presentation of updated facet browser 216 in second example user interface 220.

Updated facet browser 216 is configured to display one or more different types of the selected attribute. For example, upon selecting a “company industry” type attribute, a set of company industries such as agriculture, arts, construction, design, or finance may be displayed. Once the attribute value selection of banking is made, a global industry (finance) may be highlighted to be distinguishable from other company industries (e.g., agriculture, art, healthcare).

In an embodiment, an attribute selection causes sub-company industries (e.g., capital markets, financial services, insurance) related to the selection of the specific company industry (i.e., “banking”) to be displayed in updated facet browser 216. Each sub-related company industry is determined to be within a threshold range of similarities to the selected banking company industry. Each sub-related attribute type includes a selectable checkbox that is responsive to input selecting the sub-related attribute type. By clicking the checkbox associated with the sub-related type, the target audience may be expanded (e.g., using the disjunctive OR) or narrowed (e.g., using the conjunctive AND) to include the selected sub-related attribute type.

Related attribute button 210 in updated facet browser 216 may be activated upon a selection of an attribute type. As shown in FIG. 2B, related attribute button 210 includes a notification that shows the number of related attribute types (e.g., ten).

FIG. 2C is a third example user interface 240 when related attribute button 210 is activated. Upon activating (selecting) related attribute button 210, related attribute window 222 is presented to the content provider. Related attribute window 222 includes different types of related attributes corresponding to the input query (banking), such as company industry, a job title, a member skill, a company name, an entity interest, or an entity group. Each type of the related attributes may be presented in one side of related attribute window 222.

Upon clicking one of the related attribute types, one or more sub-related attribute values can be presented. For example, as shown in FIG. 2C, if the content provider can select a “company industry” type, then attribute values of the company industry attribute related to banking (such as capital markets, financial services, insurance, investment banking, and investment management, each related to banking as a company industry) may be presented on the other side of related attribute window 222. In some embodiments, the number of the selectable attribute values can be presented with the related attribute (e.g., six for company industries and twenty-two for job titles).

When the content provider wants to close related attribute window 222, the content provider can simply click the X button or selects related attribute button 210 to replace related attribute window 222 with facet browser 216 and transits a user interface back to second user interface 220.

### Process Overview

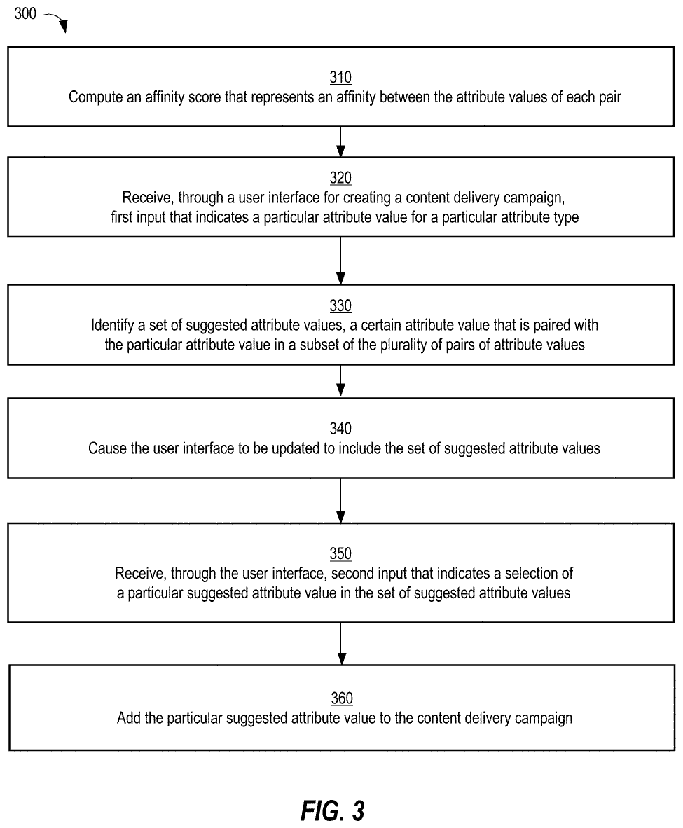

FIG. 3 is a flow diagram that depicts a process for suggesting targeting criteria for a content delivery campaign, in an embodiment. Process 300 may be implemented by content delivery system 120.

For each entity profile, content delivery system 120 identifies a set of similar profiles and identifies a set of attributes. For example, for entity A, 100 similar profiles can be identified. For each attribute value of the set of attribute values associated with each entity profile, content delivery system 120 identifies a set of pairs of each attribute value of a set of attribute values in the set of similar profiles (e.g., “title-location” pair, “title-title” pair, “title-skill” pair) or within the same entity profile. In one embodiment, a pair can be created for the same type of attribute or cross-type of the attributes. For example, a first pair may be created for a “software engineer” (title attribute) of member A and “computer engineer” (title attribute) pair of member B (same attribute). A second pair may be created for a “software engineer” (title attribute) of member A and “Mountain View” (location attribute) pair of member B (different attributes). A third pair may be created for a “software engineer” (title attribute) of member A and “JAVA” (skill attribute) of member A. A fourth pair may be created for a “software engineer” (title attribute) of member A and “San Francisco” (location attribute) of member A. For each pair of attributes, content delivery system 120 calculates attribute values.

At block 310, content delivery system 120 computes an affinity score that represents an affinity between the attribute values of each pair of a plurality of pairs of attribute values. An affinity score is a value that represents a co-occurrence of a pair of attributes. Block 310 can be performed offline before receiving first input.

At block 320, content delivery system 120 receives the first input through a user interface for creating a content delivery campaign. The first input indicates a particular attribute value for a particular attribute type. For examples, as shown in FIG. 2A, the content provider can provide the first input that indicates a particular attribute value (banking) for a particular attribute type (company industry) through content provider interface 122.

The user interface includes fields for inputting attribute values for a plurality of attribute types that includes the particular attribute type. For example, as shown in FIG. 2A, the content provider can input attribute values (banking for a company industry type or the United States for a location type).

At block 330, in response to the first input and based on affinity scores associated with the particular attribute value, a set of suggested attribute values is identified. For example, as shown in FIG. 2C, a set of suggested attribute values (capital markets, financial services, insurance) may be identified. Block 330 may involve calling profile database 150 for an affinity score for each pair.

The set of identified attribute values includes a certain attribute value that is paired with the particular attribute value in a subset of the plurality of pairs of attribute values. For example, a certain attribute value (capital markets) that is paired with the particular attribute value (banking) that is part of the subset of the plurality of pairs of attribute values (capital markets, financial services, insurance) may be identified.

In some embodiments, based on an attribute type, the number of suggestions for a first attribute type is different from the number of suggestions for a second attribute type. For example, as shown in related attributes window 222 in FIG. 3C, the number of suggestions for the member skill attribute is fifty-three (53) and the number of suggestions for the member interest attribute is twenty-six (26). Thus, different threshold values are used for different types of attributes. Content delivery system 120 determines the number of suggestions for each attribute type and limits the number of suggestions to a threshold value associated with the attribute type.

At block 340, the user interface is caused to be updated to include the set of suggested attribute values. For example, as shown in FIG. 2C, the set of suggested attribute values (capital markets, financial services, insurance) is included in content provider interface 122. The suggestions are presented as selectable options to the content provider.

In one embodiment, a “select all” button is displayed in content provider interface 122, allowing the content provider to add all the suggestions (regardless of the attribute types). In a related embodiment, a “select all suggestions of a particular attribute type” button is displayed in content provider interface 122, allowing the content provider to add all the suggestions of a single attribute. For example, by clicking the “select all suggestion of a particular attribute type” button corresponding to the company industry, all of the suggestions related to a company industry attribute can be added, but not the suggestions related to the job title attribute.

Alternatively, an individual button corresponding to each suggestion can be displayed for the content provider to choose an attribute of interest. If the content provider desires not to select any suggestions, then the content provider can simply ignore the suggestions.

At block 350, content delivery system 120 receives second input indicating a selection of a particular suggested attribute value in the set of suggested attribute values. For example, the content provider may provide the second input by selecting “financial services” in the set of suggested attribute values to expand the target audience, because the users who are associated with the financial services company industry may also be interested in a content delivery campaign as much as the users who are associated with the banking company industry.

In one embodiment, content delivery system 120 predicts an expected audience size for each selectable attribute option (before the selection is made) and displays the predicted audience size with the corresponding attribute value option, allowing the content provider to make an informed decision whether the content provider desires to expand or narrow the target audience. In another embodiment, content delivery system 120 determines a desired audience size for each content delivery campaign based on the targeting criteria and limits the audience size based on the targeting criteria for each campaign. Thus, content delivery system 120 can stop suggesting the target audience upon determining that the audience size reaches a threshold audience size. If a predicted audience size is far below the threshold audience size, then content delivery system 120 can present several suggestions that can help to reach the threshold audience size. In some embodiments, the threshold audience size can be determined based on specific input from the content provider.

At block 360, in response to receiving the second input, the particular suggested attribute value is added to the content delivery campaign. For example, when the content provider selects the financial services criteria to be associated with the target audience for a particular content delivery campaign, the targeting criteria is updated to include the financial services criteria for the particular content delivery campaign and stored in the database.

Once the content provider completes the selection of the suggested attributes and clicks a “save audience” button in the user interface, targeting criteria for the particular campaign is stored.

### Hardware Overview

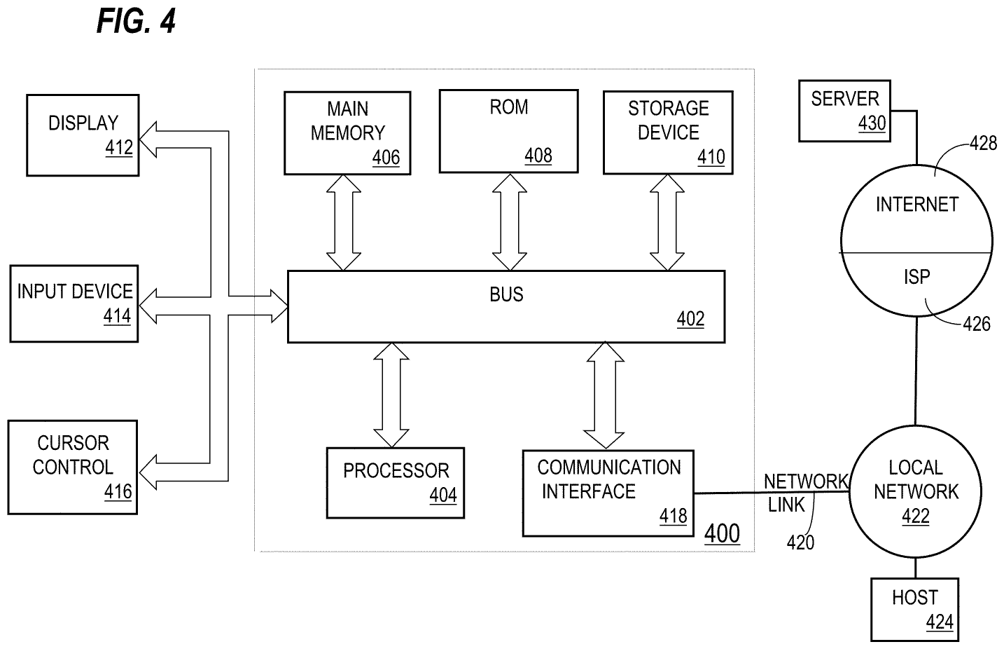

FIG. 4 is a block diagram that illustrates an example computer system with which an embodiment may be implemented. In the example of FIG. 4, a computer system 400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 400 includes an input/output (I/O) subsystem 402 which may include a bus and/or other communication mechanism(s) for communicating information and/or instructions between the components of the computer system 400 over electronic signal paths. The I/O subsystem 402 may include an I/O controller, a memory controller and at least one I/O port. The electronic signal paths are represented schematically in the drawings, for example as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU) or a digital signal processor or ARM processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read only memory (ROM) 408 or other static storage device coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as FLASH memory, or solid-state storage, magnetic disk or optical disk such as CD-ROM or DVD-ROM, and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 400 may be coupled via I/O subsystem 402 to at least one output device 412. In one embodiment, output device 412 is a digital computer display. Examples of a display that may be used in various embodiments include a touch screen display or a light-emitting diode (LED) display or a liquid crystal display (LCD) or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to I/O subsystem 402 for communicating signals, data, command selections or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on output device (e.g., display) 412. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 414 may include a combination of multiple different input devices, such as a video camera and a depth sensor.

In another embodiment, computer system 400 may comprise an internet of things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware and interfaces for generating position reporting packets, notifications, pulse or heartbeat signals, or other recurring data transmissions that specify a position of the computer system 400, alone or in combination with other application-specific data, directed toward host 424 or server 430.

Computer system 400 may implement the techniques described herein using customized hard-wired logic, at least one ASIC, GPU, or FPGA, firmware and/or program instructions or logic which when loaded and used or executed in combination with the computer system causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 402. Transmission media can also take the form of acoustic or light waves, such as those generated during radio-wave and infra-red data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to bus 402. Communication interface 418 provides a two-way data communication coupling to network link(s) 420 that are directly or indirectly connected to at least one communication networks, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 422 broadly represents a local area network (LAN), wide-area network (WAN), campus network, internetwork or any combination thereof. Communication interface 418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through a network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a world-wide packet data communication network represented as internet 428. A server computer 430 may be coupled to internet 428. Server 430 broadly represents any computer, data center, virtual machine or virtual computing instance with or without a hypervisor, or computer executing a containerized program system such as DOCKER or KUBERNETES. Server 430 may represent an electronic digital service that is implemented using more than one computer or instance and that is accessed and used by transmitting web services requests, uniform resource locator (URL) strings with parameters in HTTP payloads, API calls, app services calls, or other service calls. Computer system 400 and server 430 may form elements of a distributed computing system that includes other computers, a processing cluster, server farm or other organization of computers that cooperate to perform tasks or execute applications or services. Server 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 430 may comprise a web application server that hosts a presentation layer, application layer and data storage layer such as a relational database system using structured query language (SQL) or no SQL, an object store, a graph database, a flat file system or other data storage.

Computer system 400 can send messages and receive data and instructions, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage 410, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A method comprising:
for each pair of attribute values of a plurality of pairs of attribute values, computing an affinity score that represents an affinity between the attribute values of said each pair;
receiving, through a user interface for creating a content delivery campaign, first input that indicates a particular attribute value for a particular attribute type;
wherein the user interface includes fields for inputting attribute values for a plurality of attribute types that includes the particular attribute type;
in response to receiving the first input, based on affinity scores associated with the particular attribute value, identifying a set of suggested attribute values, wherein each attribute value in the set of suggested attribute values is paired with the particular attribute value;
causing the user interface to be updated to include the set of suggested attribute values;
receiving, through the user interface, second input that indicates a selection of a particular suggested attribute value in the set of suggested attribute values;
in response to receiving the second input, adding the particular suggested attribute value to the content delivery campaign;
wherein the method is performed by one or more computing devices.

2. The method of claim 1, wherein the particular attribute value is of a first type and the set of suggested attribute values includes an attribute value that is of a second type that is different than the first type.

3. The method of claim 2, wherein:
the set of suggested attribute values includes an attribute value that is of a third type that is different than the first type and the second type;
the number of attribute values, in the set of suggested attribute values, that are of the second type are limited to a first threshold number;
the number of attribute values, in the set of suggested attribute values, that are of the third type are limited to a second threshold number that is different than the third threshold number.

4. The method of claim 2, wherein:
the set of suggested attribute values includes an attribute value that is of a third type that is different than the first type and the second type;
the method further comprising:
receiving a single instance of third input that indicates a selection of all the attribute values in the set of suggested attribute values;
in response to receiving the single instance of third input, adding the set of suggested attributes to the content delivery campaign.

5. The method of claim 2, wherein:
the set of suggested attribute values includes a first plurality of attribute values of the second type;
the set of suggested attribute values includes a second plurality of attribute values of a third type that is different than the first type and the second type;
the method further comprising:
receiving a single instance of third input that indicates a selection of all the attribute values, in the set of suggested attribute values, that are of the second type;
in response to receiving the single instance of third input, adding the first plurality of attribute values to the content delivery campaign without adding any of the second plurality of attribute values to the content delivery campaign.

6. The method of claim 1, further comprising:
for each pair of attribute values of a plurality of pairs of attribute values, computing a local affinity score that represents an affinity between the attribute values of said each pair within a particular region.

7. The method of claim 1, further comprising:
storing an entity ranking model that takes, as input, two types of affinity scores and generates an entity ranking based on the affinity scores and one or more weights associated with the two types of affinity scores.

8. The method of claim 7, further comprising:
using one or more machine learning techniques to train the entity ranking model based on training data;
wherein training the entity ranking model involves learning the one or more weights.

9. The method of claim 1, wherein the particular attribute value is of a first type and the set of suggested attribute values includes an attribute value that is of the first type.

10. The method of claim 1, wherein the affinity score is computed based on a normalized value of the number of co-occurrences between two attributes and a total number of the plurality of pairs of attribute values.

11. The method of claim 1, wherein the plurality of attribute types includes two or more of job title, industry, skill, geolocation, companies, seniority, job function, degree, field of study, and years of experience.

12. A system comprising:
a processor; and
a memory storing instructions that, when executed by the processor, cause the processor to perform a method comprising:
for each pair of attribute values of a plurality of pairs of attribute values, computing an affinity score that represents an affinity between the attribute values of said each pair;
receiving, through a user interface for creating a content delivery campaign, first input that indicates a particular attribute value for a particular attribute type;
wherein the user interface includes fields for inputting attribute values for a plurality of attribute types that includes the particular attribute type;
in response to receiving the first input, based on affinity scores associated with the particular attribute value, identifying a set of suggested attribute values, wherein each attribute value in the set of suggested attribute values is paired with the particular attribute value;
causing the user interface to be updated to include the set of suggested attribute values;
receiving, through the user interface, second input that indicates a selection of a particular suggested attribute value in the set of suggested attribute values;
in response to receiving the second input, adding the particular suggested attribute value to the content delivery campaign;
wherein the method is performed by one or more computing devices.

13. The system of claim 12, wherein the particular attribute value is of a first type and the set of suggested attribute values includes an attribute value that is of a second type that is different than the first type.

14. The system of claim 13, wherein:
the set of suggested attribute values includes an attribute value that is of a third type that is different than the first type and the second type;
the number of attribute values, in the set of suggested attribute values, that are of the second type are limited to a first threshold number;
the number of attribute values, in the set of suggested attribute values, that are of the third type are limited to a second threshold number that is different than the third threshold number.

15. The system of claim 13, wherein:
the set of suggested attribute values includes an attribute value that is of a third type that is different than the first type and the second type;
the method further comprising:
receiving a single instance of third input that indicates a selection of all the attribute values in the set of suggested attribute values;
in response to receiving the single instance of third input, adding the set of suggested attributes to the content delivery campaign.

16. The system of claim 13, wherein:
the set of suggested attribute values includes a first plurality of attribute values of the second type;
the set of suggested attribute values includes a second plurality of attribute values of a third type that is different than the first type and the second type;
the method further comprising:
receiving a single instance of third input that indicates a selection of all the attribute values, in the set of suggested attribute values, that are of the second type;
in response to receiving the single instance of third input, adding the first plurality of attribute values to the content delivery campaign without adding any of the second plurality of attribute values to the content delivery campaign.

17. The system of claim 12, further comprising:
for each pair of attribute values of a plurality of pairs of attribute values, computing a local affinity score that represents an affinity between the attribute values of said each pair within a particular region.

18. The system of claim 12, further comprising:
storing an entity ranking model that takes, as input, two types of affinity scores and generates an entity ranking based on the affinity scores and one or more weights associated with the two types of affinity scores.

19. The system of claim 18, further comprising:
using one or more machine learning techniques to train the entity ranking model based on training data;
wherein training the entity ranking model involves learning the one or more weights.

20. The system of claim 12, wherein the particular attribute value is of a first type and the set of suggested attribute values includes an attribute value that is of the first type.
